(19) United States
(12) Patent Application Publication
(10) Pub. No.: US 2024/0385284 A1
(43) Pub. Date: Nov. 21, 2024

(54) VEHICLE ASSEMBLY COMPRISING A RADAR SENSOR AND AN ARRANGEMENT OF LAYERS

(71) Applicant: VALEO VISION, Bobigny (FR)

(72) Inventors: Pierre RENAUD, Bobigny (FR); Pierre ALBOU, Bobigny (FR); Frederic HAYES, Bobigny (FR)

(73) Assignee: VALEO VISION, Bobigny (FR)

(21) Appl. No.: 18/695,997

(22) PCT Filed: Sep. 12, 2022
(86) PCT No.: PCT/EP2022/075323

§ 371 Date: Mar. 27, 2024

(30) Foreign Application Priority Data
Oct. 1, 2021 (FR) FR2110396

(51) Int. Cl. G01S 7/02; G01S 7/03; G01S 13/931

(52) U.S. Cl. CPC G01S 7/028; G01S 7/03; G01S 13/931; G01S 2013/93271

(57) ABSTRACT

The invention relates to an assembly for a vehicle that detects a target object in the environment of the vehicle. The assembly includes a radar sensor with at least one transmit antenna and at least two receive antennas, an arrangement of layers including (i) a primary layer arranged facing the radar sensor with an exit surface for return radar waves, and (ii) at least one secondary layer with an entry surface for return radar waves, and (iii) at least one predetermined non-planar form present in the primary layer or in at least one secondary layer. The exit surface of the primary layer is computed on the basis of the at least one predetermined form such that return waves reach the at least two receive antennas with the same angle of incidence regardless of the position of the target object.

### TECHNICAL FIELD

The present invention relates to a vehicular assembly. It is particularly, but not solely, applicable to detection of an object located in the environment of a motor vehicle.

### BACKGROUND OF THE INVENTION

A vehicular assembly configured to detect an object in the environment of a vehicle comprises, in a manner known to those skilled in the art:
a radar sensor comprising at least one transmit antenna configured to transmit radar waves and at least two receive antennas configured to receive return radar waves reflected by an object, said radar sensor being configured to measure a phase difference between the return radar waves received by each receive antenna,
a layered arrangement comprising at least one layer placed facing said radar sensor.

The layered arrangement forms an illuminated logo or forms layers of a headlamp including the outer lens, or layers of a tail lamp including the outer lens.

One drawback of this prior art is that if the outer lens of the headlamp or tail lamp of the vehicle has a large curvature, this creates computation errors in the angular position of the object. The same is true if the illuminated logo has a relief. Indeed, for certain targets, there is a risk that the return radar waves will not reach the two receive antennas at certain angles of incidence. Therefore, either the target is not detected, or multiple targets may be confounded.

### SUMMARY OF THE INVENTION

In this context, the present invention aims to provide a vehicular assembly allowing the mentioned drawback to be solved.

To this end, the invention provides a vehicular assembly for a vehicle, said vehicular assembly being configured to detect a target object in the environment of said vehicle and comprising:
a radar sensor comprising at least one transmit antenna configured to transmit radar waves and at least two receive antennas configured to receive return radar waves reflected by said target object,
a layered arrangement comprising:
i) a primary layer placed facing said radar sensor and comprising an exit surface of the return radar waves, and
(ii) at least one secondary layer comprising an entrance surface of the return radar waves, and
(iii) at least one non-planar predetermined shape present in the primary layer or in at least one secondary layer,
characterized in that said exit surface of the primary layer is computed depending on said at least one predetermined shape, so that return waves reach said at least two receive antennas with the same angle of incidence regardless of the position of the target object.

According to non-limiting embodiments, said vehicular assembly may further comprise, alone or in any technically possible combination, one or more additional features selected from the following.

According to one non-limiting embodiment, said primary layer and said at least one secondary layer are merged into a single layer.

According to one non-limiting embodiment, said primary layer and said at least one secondary layer are distinct and have a different refractive index.

According to one non-limiting embodiment, said exit surface of the primary layer is computed according to the equation A(u, 0)=A(u, L) for any angle u within the field of view of said radar sensor, L being the distance between said at least two receive antennas.

According to one non-limiting embodiment, the shape of said exit surface is determined by a finite-difference method.

According to one non-limiting embodiment, said phase difference measured by said radar sensor is corrected by a correction function of a processing unit of the vehicle.

According to one non-limiting embodiment, the layered arrangement forms a logo or layers of a headlamp or tail lamp.

According to one non-limiting embodiment, the predetermined shape is a relief formed from planar or conical surfaces.

According to one non-limiting embodiment, the exit surface of the primary layer is partly planar and comprises a portion that is set back or raised with respect to said planar part and that is configured to compensate for a shift induced by said predetermined shape in said phase difference between the return radar waves received by each receive antenna.

According to one non-limiting embodiment, the primary layer has a primary refractive index, and said layered arrangement comprises two secondary layers each with a secondary refractive index and a tertiary refractive index, respectively, one layer of said layers comprising the entrance surface of the return radar waves and possessing the tertiary refractive index, said entrance surface being partially parallel to said exit surface and the tertiary refractive index being the same as the primary refractive index.

According to one non-limiting embodiment, the predetermined shape is curved and is a smooth surface.

Also provided is a layered arrangement placed facing a radar sensor, said radar sensor comprising at least one transmit antenna configured to transmit radar waves and at least two receive antennas configured to receive return radar waves reflected by a target object, said layered arrangement comprising:
(i) a primary layer placed facing said radar sensor and comprising an exit surface of the return radar waves,
(ii) at least one secondary layer comprising an entrance surface of the return radar waves,
at least one non-planar predetermined shape present in the primary layer or in at least one secondary layer,
characterized in that said exit surface of the primary layer is computed depending on said at least one predetermined shape of said entrance surface, so that return waves reach said at least two receive antennas with the same angle of incidence regardless of the position of the target object.

### BRIEF DESCRIPTION OF DRAWINGS

The invention and the various applications thereof will be better understood on reading the following description and studying the accompanying figures, in which:

FIG. 1 is a schematic view of a vehicular assembly, with said vehicular assembly comprising a radar sensor and a layered arrangement, according to one non-limiting embodiment of the invention,

FIG. 2 is a schematic view of two return radar waves corresponding to a radar wave transmitted by the radar sensor of the vehicular assembly of FIG. 1 striking the layered arrangement of the vehicular assembly of FIG. 1, said layered arrangement comprising a first layer and a second layer, the first layer and the second layer being distinct, according to a first non-limiting variant of a first non-limiting embodiment,

FIG. 3 is a schematic view of two return radar waves corresponding to a radar wave transmitted by the radar sensor of the vehicular assembly of FIG. 1 striking the layered arrangement of the vehicular assembly of FIG. 1, said layered arrangement comprising a first layer and a second layer, the first layer and the second layer being distinct, according to a second non-limiting variant of a first non-limiting embodiment,

FIG. 4 is a schematic view of two return radar waves corresponding to a radar wave transmitted by the radar sensor of the vehicular assembly of FIG. 1 striking the layered arrangement of the vehicular assembly of FIG. 1, said layered arrangement comprising a first layer, a second layer and a third layer, the first layer, the second layer and the third layer being distinct, according to a second non-limiting embodiment,

FIG. 5 is a schematic view of two return radar waves corresponding to a radar wave transmitted by the radar sensor of the vehicular assembly of FIG. 1 striking the layered arrangement of the vehicular assembly of FIG. 1, said layered arrangement comprising a first layer and a second layer, the first layer and the second layer being merged, according to a third non-limiting embodiment, and

FIG. 6 is a figure allowing a computation of an exit surface of the layered arrangement of the vehicular assembly of FIG. 1 depending on an entrance surface of said layered arrangement to be explained, for a layered arrangement comprising a first layer and a second layer, the first layer and the second layer being merged, according to one non-limiting embodiment.

### DETAILED DESCRIPTION OF THE INVENTION

Elements that are identical in terms of structure or function and that appear in various figures have been designated by the same references, unless indicated otherwise.

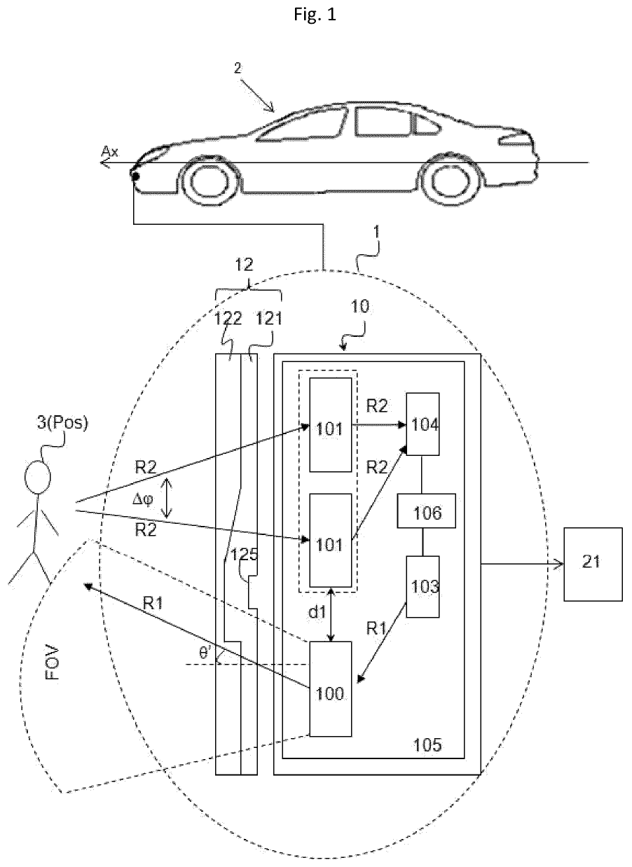

The vehicular assembly 1 for a vehicle 2 according to the invention will now be described with reference to FIGS. 1 to 6. In one non-limiting embodiment, the vehicle 2 is a motor vehicle. By motor vehicle, what is meant is any type of motorized vehicle. This embodiment will be considered, by way of non-limiting example, in the remainder of the description. Throughout the remainder of the description, the vehicle 2 is thus also called the motor vehicle 2. The motor vehicle 2 comprises a processing unit 21. In one non-limiting embodiment, this processing unit 21 is integrated into the radar sensor 10 described below. In the non-limiting example considered, it is located outside the radar sensor 10 and the vehicular assembly 1.

The vehicular assembly 1 is configured to detect an object 3, also called the target 3, in the environment of the motor vehicle 2. As shown in FIG. 1, the vehicular assembly 1 (also called the vehicle arrangement 1) comprises:
a radar sensor 10 configured to transmit/receive radar waves R1, R2, respectively,
a layered arrangement 12.

These elements are described below.

The radar sensor 10 is described below. As illustrated in FIG. 1, the radar sensor 10 is placed facing the layered arrangement 12. In one non-limiting embodiment, the radar sensor 10 is a millimeter-wave (between 24 GHz and 300 GHz) or low-terahertz (between 300 MHz and 81 GHz) or microwave (between 1 GHz and 300 GHz) radar sensor. In one non-limiting variant, the radar sensor 10 operates at a radar frequency between 76 GHz and 81 GHz. In one non-limiting embodiment, the radar waves R1 are transmitted in a frequency band between 100 MHz and 5 GHz. Thus, in one non-limiting example, if the radar sensor 10 operates at a radar frequency of 77 GHz, i.e. a wavelength A of 3.95 mm, with a frequency band of 1 GHZ, the radar sensor 10 will operate in a frequency band from 76.5 GHz to 77.5 GHz. The radar waves R1 will thus be transmitted in the frequency range 76.5 GHz to 77.5 GHZ, i.e. a range of wavelengths λ from 3.87 mm to 3.92 mm. Thus, in another non-limiting example, if the radar sensor 10 operates at a radar frequency of 78.5 GHz with a frequency band of 5 GHZ, the radar sensor 10 will operate in a frequency band from 76 GHz to 81 GHz. The radar waves R1 will thus be transmitted in the frequency range 76 GHz to 81 GHZ, i.e. a range of wavelengths λ from 3.701 mm to 3.945 mm.

As illustrated in FIG. 1, the radar sensor 10 possesses a field of view FOV. The transmitted radar waves R1 strike the layered arrangement 12 with an angle of incidence θ′. In one non-limiting embodiment, the angle of incidence θ′ is between 0° and +/−30°. The field of view FOV thus varies between −30° and +30°. The center of the field of view FOV is an angle of 0° with respect to the longitudinal axis of the vehicle, which is also called the axis Ax of the vehicle. In another non-limiting embodiment, the field of view FOV thus varies between −90° and +45°. The center of the field of view FOV is at an angle of −45° to the axis Ax of the vehicle and the angle of incidence θ′ of the radar waves R1 on the layered arrangement 12 remains close to 0° (the vehicular assembly 1 then being positioned at about 45° to the axis Ax of the vehicle).

In one non-limiting embodiment, the radar sensor 10 is placed in a headlamp, in a tail lamp or in an, optionally illuminated, logo of the motor vehicle 2.

The radar sensor 10 is configured to scan the environment outside the motor vehicle 2, by virtue of transmission of radar waves R1. As illustrated in FIG. 1, the radar sensor 10 thus comprises:
at least one transmit antenna 100 configured to transmit radar waves R1, also called primary radar waves R1, or transmitted radar waves R1,
at least two receive antennas 101 configured to receive radar waves R2, also called secondary radar waves R2 or return radar waves R2.

The radar sensor 10 further comprises at least one transmitter 103 configured to generate the primary radar waves R1 and at least one receiver 104 configured to process the secondary radar waves R2 received in return. In one non-limiting embodiment, a single electronic component may be used for both the transmit and receive functions. There will thus be one or more transceivers. Said transmitter 103 generates primary radar waves R1, which are subsequently transmitted by the transmit antenna 100, and which, when they encounter an object 3 (here a pedestrian in the non-limiting example illustrated) in the environment outside the motor vehicle 2, are reflected by said object 3. The radar waves thus reflected are waves that are transmitted back to the radar sensor 10. These are the secondary radar waves R2 received by the receive antennas 101. These are radar waves transmitted back in the direction of the radar sensor 10. The radar sensor 10 is configured to measure the phase difference Δφ between the return radar waves R2 received by each receive antenna 101. It will be recalled that propagation of the return radar waves R2 is described by Snell's law. In one non-limiting embodiment, the primary radar waves R1 and the secondary radar waves R2 are radio-frequency waves. In one non-limiting embodiment, the radar sensor 10 comprises a plurality of transmitters 103 and a plurality of receivers 104.

The transmit antenna 100, also referred to as the antenna 100, is configured to transmit the primary radar waves R1 generated by the transmitter 103. The receive antennas 101, also called the antennas 101, are configured to receive the secondary radar waves R2 and communicate them to the receiver 104, which subsequently processes them. A phase shift Δφ , also called the phase difference Δφ , exists between the secondary radar waves R2 received by the receive antennas 101, and the angular position Pos of the object 3 with respect to the motor vehicle 2 may be deduced therefrom, the object 3 being located in the environment outside the motor vehicle 2. The radar sensor 10 is thus configured to measure this phase difference Δφ between the secondary radar waves R2 received by each receive antenna 101. In non-limiting embodiments, the antennas 100, 101 are patch antennas or slot antennas.

In one non-limiting embodiment, the antennas 100, 101, the transmitter 103 and the receiver 104 are arranged on a printed circuit board 105. In one non-limiting embodiment, the printed circuit board is a printed circuit board assembly (PCBA) or a flexible printed circuit board (flexboard).

The radar sensor 10 further comprises an electronic control unit 106 configured to control the transmitter 103 and the receiver 104. Since such a radar sensor is known to those skilled in the art, it will not be described in more detail here.

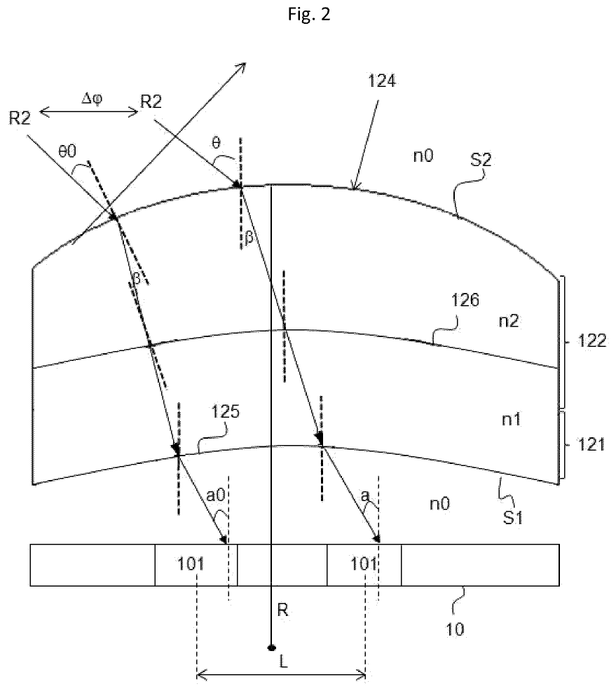

The layered arrangement 12 is described below. As illustrated in FIGS. 2 to 5, it comprises:
a primary layer 121, and
at least one secondary layer 122.

In non-limiting embodiments, the layered arrangement 12 forms an, optionally illuminated, logo or forms layers of a headlamp or tail lamp of the motor vehicle 2, such as the outer lens or the outer lens and a decorative part called a mask.

The primary layer 121 is placed facing the radar sensor 10 and comprises an exit surface S1 of the return radar waves R2. In one non-limiting embodiment, the primary layer 121 is made of plastic. The exit surface S1 forms a dioptric interface between the material of the primary layer 121 (which has a refractive index n1) and air (of refractive index n0).

Said secondary layer 122 comprises an entrance surface S2 of the return radar waves R2. The return radar waves R2 strike the entrance surface S2 with an angle of incidence θ. The angle of incidence θ corresponds to a refracted angle β. The angle of incidence θ varies depending on where the return radar wave R2 meets the entrance surface S2. Thus, in the figures, a first return radar wave R2 has been shown with an angle of incidence θ0 and a second return radar wave R2 has been shown with an angle of incidence θ. The entrance surface S2 forms a dioptric interface between the material of the secondary layer 122 (which has a refractive index n2) and air (of refractive index n0).

In a first non-limiting embodiment illustrated in FIGS. 2 to 4, the primary layer 121 and said at least one secondary layer 122 are distinct and have a different respective refractive index n1, n2.

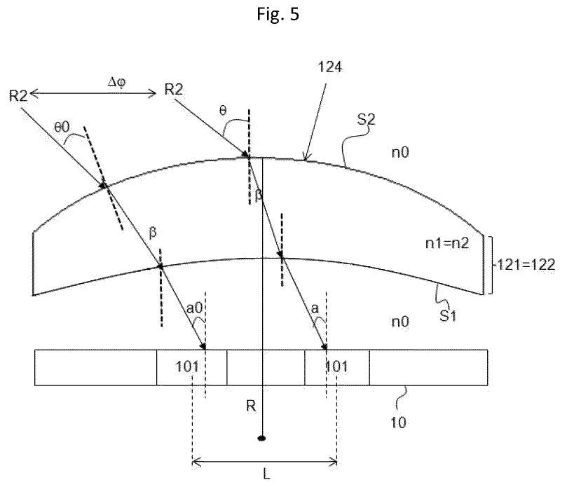

In a second non-limiting embodiment illustrated in FIG. 5, the primary layer 121 and said at least one secondary layer 122 are merged into a single layer and thus form only a single layer.

It will be noted that the secondary layer 122 comprises a predetermined shape 124. It is a 3D shape. This predetermined shape 124 is set by motor-vehicle manufacturers, often for reasons of style, and is therefore linked to the motor vehicle 2.

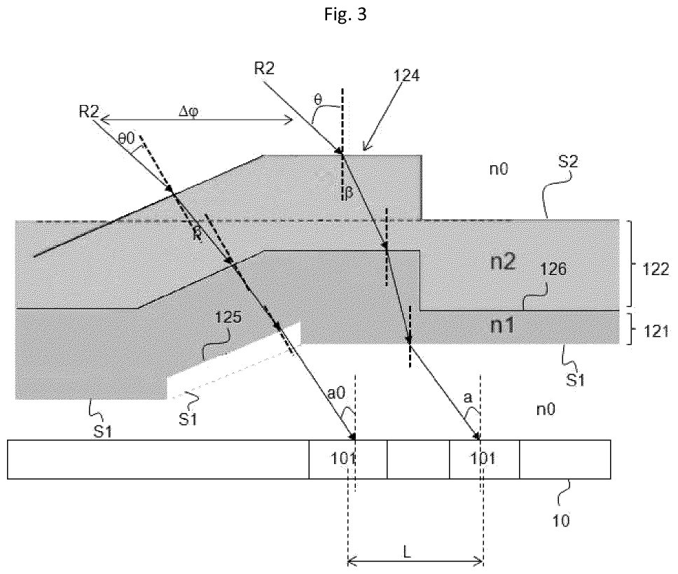

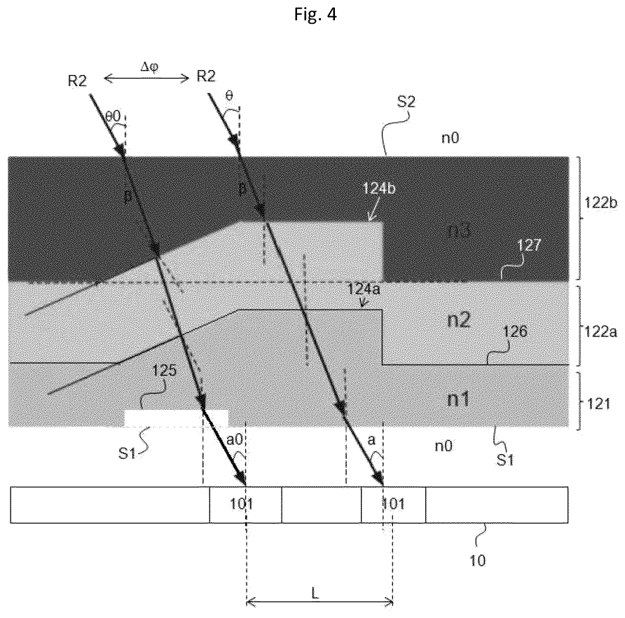

In a first non-limiting embodiment, the predetermined shape 124 is a relief formed by plane or conical surfaces (illustrated in FIG. 3 or 4) of a logo. The logo is thus in relief. The logo is optionally illuminated. In the non-limiting example of FIGS. 3 and 4, the relief 124 is trapezoidal in shape. In another non-limiting example (not shown), the relief 124 may be pyramidal in shape. In a first non-limiting variant illustrated in FIG. 3, said predetermined shape 124 forms part of the entrance surface S2 of the secondary radar waves R2. In a second non-limiting variant illustrated in FIG. 4, said predetermined shape 124 does not form part of the entrance surface S2 of the secondary radar waves R2.

In a second non-limiting embodiment, the predetermined shape 124 is a smooth surface (illustrated in FIG. 2 or 5) of a tail lamp or headlamp. By smooth, what is meant is that it contains no corners and that it not in relief, i.e. contains no asperities.

Three non-limiting embodiments of the layered arrangement 12 are described below with reference to FIGS. 2 and 3, to FIG. 4 and lastly to FIG. 5, respectively.

In a first non-limiting embodiment illustrated in FIGS. 2 and 3, the layered arrangement 12 comprises two layers, namely:
a primary layer 121, and
a secondary layer 122, the primary layer 121 and the secondary layer 122 being distinct.

According to this first non-limiting embodiment, the primary layer 121 and the secondary layer 122 are adjacent and bounded by a junction surface 126.

In a first non-limiting variant illustrated in FIG. 2, the secondary layer 122 has a predetermined shape 124 of smooth surface. In one non-limiting example, the smooth surface is curved. In this case, the angle of incidence θ0 is in general different from the angle of incidence θ for two return radar waves R2 striking the entrance surface S2 at different locations. The secondary layer 122 thus has a radius of curvature R. In this case, in one non-limiting embodiment, the layered arrangement 12 is a tail lamp or headlamp. The primary layer 121 is a substrate that allows the secondary layer 122 to be borne, and the secondary layer 122 is an outer lens of the tail lamp or headlamp. The predetermined shape 124 forms part of the entrance surface S2 of the secondary radar waves R2.

In a second non-limiting variant illustrated in FIG. 3, the secondary layer 122 has a predetermined shape 124 that is a relief. In one non-limiting example, the relief 124 is trapezoidal in shape. In this case, in one non-limiting embodiment, the layered arrangement 12 is a logo. In the second non-limiting variant, the junction surface 126 follows the shape of the entrance surface S2. It therefore lies parallel to the entrance surface S2. The predetermined shape 124 forms part of the entrance surface S2 of the secondary radar waves R2. In this case, the angle of incidence θ0 is in general different from the angle of incidence θ for two return radar waves R2 striking the entrance surface S2 at different locations.

In a second non-limiting embodiment illustrated in FIG. 4, the layered arrangement 12 comprises:
a primary layer 121,
a first secondary layer 122a, and
a second secondary layer 122b, the primary layer 121, the first secondary layer 122a and the second secondary layer 122b being distinct.

In this case, in one non-limiting example, the layered arrangement 12 is a logo. In this case, the primary layer 121 is an optical layer that also serves as a carrier for the first secondary layer 122a, the first secondary layer 122a is a film, and the second secondary layer 122b is an outer lens. The entrance surface S2 of the return radar waves R2 forms part of the second secondary layer 122b.

The first secondary layer 122a is placed between the primary layer 121 and the second secondary layer 122b. The primary layer 121 and the first secondary layer 122a are adjacent and bounded by a junction surface 126. The first secondary layer 122b and the second secondary layer 122b are adjacent and bounded by a junction surface 127.

The first secondary layer 122a comprises a predetermined shape 124a. The second secondary layer 122a comprises a predetermined shape 124b identical to that 124a of the first secondary layer 124a. The predetermined shape 124a extends along the junction surface 126. The predetermined shape 124b extends along the junction surface 127. In one non-limiting embodiment, the predetermined shapes 124a and 124b are reliefs. In one non-limiting example, these reliefs 124a, 124b are trapezoidal in shape. The junction surface 127 follows the junction surface 126. It therefore lies parallel to the junction surface 126, and the reliefs 124a, 124b face each other directly. It will be noted that neither of the predetermined shapes 124a, 124b forms part of the entrance surface S2.

The primary layer 121 possesses a primary refractive index n1. The first secondary layer 122a possesses a secondary refractive index n2. The second secondary layer 122b possesses a tertiary refractive index n3. The entrance surface S2 is partially parallel to the exit surface S1, and the tertiary refractive index n3 is the same as the primary refractive index n1. This allows the return radar waves R2 to emerge from the exit surface S1 with an angle of incidence a=a0, a that is the same as the angle of incidence θ0, θ when they strike the entrance surface S2, respectively, this making it possible to have a partly planar exit surface S1. This subsequently makes it possible to achieve phase-shift compensation as described below.

As illustrated in FIG. 4, in one non-limiting embodiment, the entrance surface S2 is planar. In this case, the angle of incidence θ0 is equal to the angle of incidence θ for two return radar waves R2 striking the entrance surface S2 at different locations.

In a third non-limiting embodiment illustrated in FIG. 5, the layered arrangement 12 comprises:
a primary layer 121, and
a secondary layer 122, the primary layer 121 and the secondary layer 122 being merged.

The entrance surface S2 is not parallel to the exit surface S1.

In one non-limiting variant illustrated in FIG. 5, the predetermined shape 124 is a smooth surface. In one non-limiting example, the smooth surface is curved and has a radius of curvature R. In this case, in one non-limiting embodiment, the layered arrangement 12, which therefore comprises only a single layer, is an outer lens of a tail lamp or headlamp. In another non-limiting variant (not shown), the predetermined shape 124 is a relief. In this case, the relevant figure would be the same as FIG. 3 but without the junction surface 126 and n2=n1.

The exit surface S1 of the primary layer 121 is computed depending on the entrance surface S2 so that the return waves R2 reach the two receive antennas 101 with the same angle of incidence a whatever the position of the target object 3.

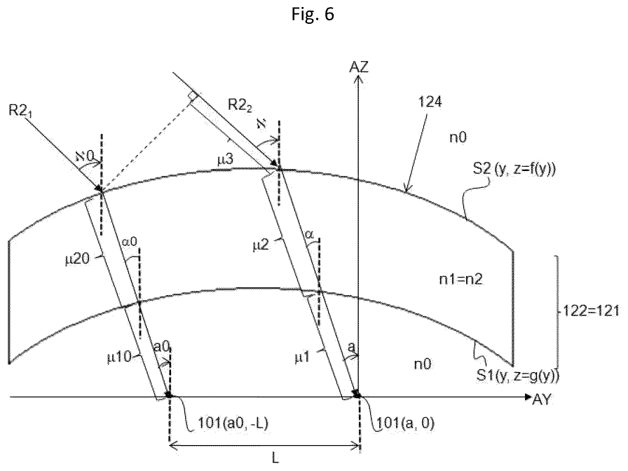

In order to determine the shape of the exit surface S1, the following computations are performed. It will be noted that the computations are performed in a horizontal plane containing the receive antennas 101. Specifically, the radar sensor 10 in question determines the azimuth of the target objects 3 but not their elevation and therefore has a field of view FOV of low elevation. The entrance surface S2, the exit surface S1 and the predetermined shape 124 are assumed to have zero curvatures and must in practice have small curvatures in vertical sections perpendicular to the AZ-AY plane of FIG. 6. In other words, the useful portions thereof are assumed to be surfaces that are cylindrical, of axis perpendicular to the AZ-AY plane and of any right cross section.

Let:
g be the shape of the exit surface S1 that is sought, with g a function such that all the points of the exit surface S1 have as coordinates (y, z=g(y)) in the coordinate system Ay-Az;
f be the predetermined shape 124, with f a function such that all the points of the predetermined shape 124 have coordinates (y, z=f(y)) in the coordinate system Ay-Az; and
d be a real number that is any distance.

Let y1 and y2 be homogeneous functions of coordinates along the horizontal axis AY perpendicular to the vehicle axis Ax, and A be the solutions of the following equations.
y1(u, d) is the solution of the equation:

$$g ( y ) tan ( u ) - y + d = 0 \qquad [ Math 1 ]$$

Thus y1 is the solution of an equation that is dependent on g.

Let w be an angle:

$$w ( u , d ) = arcsin ( \frac{1}{n} sin ( u + arctan ( \frac{dg}{dy} ( {y}_{1} ( u , d ) ) ) ) ) - arctan ( \frac{dg}{dy} ( {y}_{1} ( u , d ) ) ) \qquad [ Math 2 ]$$

y2(u, d) is then the solution of the equation:

$$f ( y ) tan ( w ( u , d ) ) - y - \frac{{y}_{1} ( u , d )}{tan ( u )} tan ( w ( u , d ) ) + {y}_{1} ( u , d ) = 0 \qquad [ Math 3 ]$$

$$Then$$

$$A ( u , d ) = arcsin ( n . sin ( w ( u , d ) + arctan ( \frac{df}{dy} ( {y}_{2} ( u , d ) ) ) ) ) - arctan ( \frac{df}{dy} ( {y}_{2} ( u , d ) ) ) \qquad [ Math 4 ]$$

As f (which describes the predetermined shape 124) is set, g is the solution, when any exists, of A(u, 0)=A(u, L)(differential equation) for all angles u within the field of view FOV of the radar sensor 10.

To solve the equation A(u, 0)=A(u, L), a finite-difference method or the finite-element method, or a step-by-step method, is used in non-limiting embodiments. A finite-difference method for solving the equation is described below.

In practice, χ0=A(a0, 0) and χ=A(a, L) are computed as follows.

To explain the computations, reference is made to FIG. 6, which shows the receive antennas 101 of the radar sensor 10, and the layered arrangement 12 in which the primary layer 121 and the secondary layer 122 are merged and therefore have a refractive index n1=n2. For the computations, the receive antennas 101 are considered to be point-like. They are separated from each other by a distance L. A coordinate system Y, Z is used with Z parallel to the axis of sight of the radar sensor 10 and with the axis AY perpendicular to the axis AZ. One of the receive antennas 101 is located at an abscissa y=0, the other being at an abscissa y=−L. FIG. 6 illustrates a return radar wave R21, also called the primary return radar wave R21, which is received by the receive antenna 101 of abscissa y=−L, which is denoted 101(a0, −L), and another return radar wave R22, also called the secondary return radar wave R22, which is received by the other receive antenna 101 of abscissa y=0, which is denoted 101(a, 0).

For the various computations below, the following notations are used:
g: the shape of the sought exit surface S1,
f: the predetermined shape 124,
χ0: the angle of a return radar wave R21 striking the entrance surface S2 with respect to a vertical parallel to the Z-axis, the orientation of χ0 being given by the arrow in the figure indicating said angle,
χ: the angle of the other return radar wave R22 striking the entrance surface S2 with respect to a vertical parallel to the Z-axis, the orientation of χ being given by the arrow in the figure indicating said angle. This angle χ is called the angle of incidence of the target object 3, or target angle,
a0: the angle of the primary return radar wave R21 received by the receive antenna 101(a0, −L) with respect to a vertical parallel to the Z-axis, a0 being oriented as χ0 and χ,
a: the angle of the secondary return radar wave R22 received by the receive antenna 101,(a, 0) with respect to a vertical parallel to the Z-axis, with a0=a, a being oriented as χ0 and χ
α0: the angle of the primary return radar wave R21 striking the exit surface S1 with respect to a vertical parallel to the Z-axis, α0 being oriented as χ0 and χ. The return radar wave R21 is the one that is received by a first receive antenna 101,
α: the angle of the secondary return radar wave R22 at the exit surface S1 with respect to a vertical parallel to the Z-axis, α being oriented as χ0 and χ. The other return radar wave R22 is the one received by the second receive antenna 101,
μ10: the path, also called the optical path, traced by the primary return radar wave R21 between the exit surface S1 and the receive antenna 101(a0, −L); in other words, in the figure, it is the distance along the primary return radar wave R21 between the exit surface S1 and the receive antenna 101(a0, −L). This path is traced through air,
μ20: the path, also called the optical path, traced by the primary return radar wave R21 between the entrance surface S2 and the exit surface S1; in other words, in the figure, it is the distance along the primary return radar wave R21 between the entrance surface S2 and the exit surface S1. This path is traced in the primary layer 121 (which is merged with the secondary layer 122),
μ1: the path, also called the optical path, traced by the secondary return radar wave R22 between the exit surface S1 and the receive antenna 101(a, 0); in other words, in the figure, it is the distance along the secondary return radar wave R22 between the exit surface S1 and the receive antenna 101(a, 0). This path is traced in air,
μ2: the path, also called the optical path, traced by the secondary return radar wave R22 between the entrance surface S2 and the exit surface S1; in other words, in the figure, it is the distance along the secondary return radar wave R22 between the entrance surface S2 and the exit surface S1. This path is traced in the primary layer 121 (which is merged with the secondary layer 122),
μ3: the path traced by the secondary return radar wave R22 between the normal common to the two return radar waves R21, R22 and starting from the first point of contact with the entrance surface S2. This path is traced through air. In other words, μ3 is the path difference of the return radar waves R21 and R22 to return to a phase reference that is identical for the two return radar waves R21 and R22, namely a phase difference Δφ=0.

Let z=f(y) be an equation of the entrance surface S2 and z=g(y) be an equation of the exit surface S1 in the coordinate system AY, AZ centered on the receive antenna 101 of greater γ (here y=0) of a pair of receive antennas 101. The function f is known because it is the predetermined shape 124, which is conventionally manufacturer-imposed as indicated above. The function g is sought. If the exit surface S1 is correctly shaped so that the return radar waves R21, R22 reach the receive antennas 101, then χ0=χ for any y of the support of g, for a given angle a. It will be noted that the support of g is the set of abscissas y for which the function g is defined.

This means that the rays R21 and R22 have come from the same target object 3 and form the same plane wave. Otherwise, if the exit surface S1 is not arranged correctly, then χ0≠χ. This means that the return radar waves R21 and R22 have not come from the same target object 3. The radar sensor 10 may then be misled and detect a false target object 3.

The derivatives of the functions f and g are denoted f′ and g′. It is possible to write:

$$a = arctan ( \frac{y}{g ( y )} ) \qquad [ Math 5 ]$$

$$and$$

$$α = - arctan ( {g}^{′} ( y ) ) + arcsin ( \frac{sin ( a + arctan ( {g}^{′} ( y ) ) )}{n 2} ) \qquad [ Math 6 ]$$

μ2 is a solution of:

$$g ( y ) + μ2cos ( α ) = f ( y + μ2sin ( α ) ) \qquad [ Math 7 ]$$

$$Thus :$$

$$χ = - arctan ( {f}^{′} ( y + μ 2 sin ( α ) ) ) + arcsin ( n 2 sin ( α + arctan ( {f}^{′} ( y + μ2sin ( α ) ) ) ) ) \qquad [ Math 8 ]$$

This formula is referenced formula [1]. Furthermore, μ10 is a solution of:

$$μ 10 cos ( a ) = g ( μ 10 sin ( a ) - L ) \qquad [ Math 9 ]$$

with L the separation (or distance) between the two receive antennas 110. Then:

$$α 0 = - arctan ( {g}^{′} ( μ10sin ( a ) - L ) ) + arcsin ( \frac{sin ( a + arctan ( {g}^{′} ( μ10sin ( a ) - L ) ) )}{n 2} ) \qquad [ Math 10 ]$$

Furthermore, μ20 is a solution of:

$$g ( μ 10 sin ( a ) - L ) + μ 20 cos ( α0 ) = f ( μ 10 sin ( a ) - L + μ 20 sin ( α0 ) ) \qquad [ Math 11 ]$$

The following is thus obtained:

$$χ 0 = - arctan ( {f}^{′} ( μ10sin ( a ) - L + μ 20 sin ( α0 ) ) ) + arcsin ( n 2 sin ( α0 + arctan ( {f}^{′} ( μ10sin ( a ) - L + μ 20 sin ( α0 ) ) ) ) ) \qquad [ Math 12 ]$$

It may be seen that if g is known, it is possible to meet the condition χ0=χ for any y.

Conversely, this condition χ0=χ makes it possible to determine g.

In one non-limiting embodiment, g is determined, approximately, by a finite-difference method. One non-limiting example of a finite-difference method is described below.

A finite subset of abscissas y1 to ym (i.e. yi, with i=1 to m, m an integer) of the support of g is selected and the values gi=g(yi) are sought. This allows sampling or in other words discretization to be carried out. To do this, an approximation g′i of the derivative of g with respect to yi must be chosen. In one non-limiting embodiment, the approximation g′i is equal to:

$${g}_{5 ′i} = \frac{{g}_{i + 1} - {g}_{i - 1}}{{y}_{i + 1} - {y}_{i - 1}} \qquad [ Math 13 ]$$

g′ makes it possible to determine the direction of the normal to the surface of S1 for a given abscissa y, which direction is required to compute the propagation of the return radar waves R2 through the layered arrangement 12.

Thus, by virtue of this formula, the gi values are chosen until χ0=χ is approached. The equation A(u, 0)=A(u, L) described above is thus solved for all the chosen points gi. In other words, χ0-χ is minimized for all the points yi. g will thus be known for all the values of gi thus chosen.

Next, once the values of gi have been chosen, which values correspond to points gi on the support of g, the function g is interpolated between the points gi and g′i at the abscissae yi.

In one non-limiting variant, g and g′ may be approximated by linear piecewise functions passing through the points (yi, gi) and the points (yi, g′i). In another non-limiting variant, g and g′ may be approximated by spline curves or any other form of interpolation.

It is then possible, for any set of values gi, to meet the condition χ0=χ for all the yi.

Estimating g then amounts to finding the set {gi, i=1 to m} allowing the condition χ0=χ to be best met for all the yi.

If a metric M is chosen, the problem is then one of optimization of a finite set of variables (here gi), for which problem there are many known optimization algorithms. In non-limiting embodiments, it is possible to use simulated-annealing or line-search methods, in which methods a parallel to the imposed entrance surface is used as starting point. The gi of a surface parallel to the entrance surface S2 is thus used to start the optimization.

In one non-limiting embodiment, the metric M is the sum of the absolute values of the difference between χ0 and χ for all yi(i=1 to m, m an integer). Thus,

$$M = {\sum }_{i = 1}^{m} \vert χ ( {y}_{i} ) - χ 0 ( {y}_{i} ) \vert \qquad [ Math 14 ]$$

This metric, which depends on all the points yi, must be minimized. Specifically, to find the values of gi, this metric M must thus be minimized.

If the abscissae yi are evenly spaced over a finite support, gi tends to g(yi) when m tends to infinity. In other words, if the samples are separated by a constant pitch, the solution is converged toward if there are many points yi. gi is the discretized and approximate solution, and g(yi) is the exact solution. It will be noted that the minimum number m of points yi required to achieve a given precision depends on the approximations (namely the g′i) of the interpolations and on the chosen metric M. In another non-limiting embodiment, the metric M is the square root of the sum of the differences squared between χ0 and χ for all yi (i=1 to m, m an integer).

Thus, the shape g of the exit surface S1 that allows the return radar waves R2 to reach the two receive antennas 101 is found. Thus, the radar sensor 10 will not see any false target objects 3.

It will be noted that the same reasoning may be applied for a layered arrangement in which the primary layer 121 and said at least one secondary layer 122 are distinct, and for any layered arrangement 12 comprising a primary layer 121 and a plurality of secondary layers 122.

It will be noted that, because of the predetermined shape 124 of the secondary layer 122, the phase difference Δφ measured by the radar sensor 10 between two return radar waves R2 does not follow the conventional formula of radar sensors 10, namely Δφ0=2π·L·sin(a)/λ, but rather the following more complex law. For a target located in the angular direction χ with respect to the axis of the radar sensor 10 (represented by AZ in FIG. 6), the radar sensor 10 will measure the following phase shift Δφ:

$$Δφ = 2 π \frac{μ 3 + n 2 ( μ 2 - μ 20 ) + μ 1 - μ 10}{λ} \qquad [ Math 15 ]$$

This formula is referenced formula [2]. A measurement of the azimuth of the target deduced from the phase shift Δφ via the conventional formula would thus be erroneous since the phase shift Δφ does not obey the conventional formula.

It is possible to write:

$$μ 1 = \sqrt{{y}^{2} + {g ( y )}^{2}} \qquad [ Math 16 ]$$

$$μ3 = sin ( χ0 - arctan ( \frac{f ( y 2 ) - f ( y 20 )}{y 2 - y 20} ) ) \sqrt{{( f ( y 2 ) - f ( y 20 ) )}^{2} + {( y 2 - y 20 )}^{2}} \qquad [ Math 17 ]$$

$$with$$

$$y 2 = y + μ2sin ( α ) \qquad [ Math 18 ]$$

$$y 20 = μ 10 sin ( a ) - L + μ 20 sin ( α0 ) \qquad [ Math 19 ]$$

The radar sensor 10 will thus deliver an angle of incidence of the target object 3, also called the target angle ea(y):

$$ea ( y ) = arcsin ( \frac{Δφ}{2 π} \frac{λ}{L} ) \neq χ \qquad [ Math 20 ]$$

This formula is referenced formula [3].

To correct this erroneous measurement, in one non-limiting embodiment, the processing unit 21 is configured to apply a correction function f1 to the angle of incidence ea(y) to correct the error due to the phase difference Δφ measured by the radar sensor 10.

From formula [1], f and f are known. α and μ2 are dependent on g. g is known for a given y. The processing unit 21 is therefore able to compute χ(y) as described above. In formula [2], Δφ is dependent on g and f. The processing unit 21 is therefore able to compute Δφ(y) and therefore to compute the target angle ea(y) (formula [3]) that will be delivered by the radar sensor 10. The processing unit 21 will thus provide the correction function f1(EA)=χ(ea−1(EA)), where EA is an angular target position returned by the radar and f1(EA) the true azimuth of this target.

In one non-limiting embodiment, the processing unit 21 is further configured to compute the angular position Pos of a target object 3 from the phase difference Δφ after correction.

It will be noted that the element 12 in general creates, for a given target of azimuth χ, a phase difference Δφ between the secondary radar waves R2 received by each receive antenna 101 that is different from the phase difference that would exist in the absence of said element 12 or if the latter were composed solely of layers of parallel planar faces, which phase difference would then be

$$Δφ0 = 2 π \frac{Lsin ( χ )}{λ} .$$

The actual phase difference Δφ is given by formula [2] above. The radar sensor 10 computes χ on the basis of the phase difference Δφ0. If it can be ensured that Δφ−Δφ0=0 modulo 2π (compensation), the radar will correctly measure χ without the need to call upon the function f1. This compensation may be achieved by modifying the optical path traced by one of the return radar waves R2 received by one of the two receive antennas 101. The optical-path modification to be achieved is equal to: c=(((Δφ−Δφ0)+n*2π)/2π)*λ, with n an integer. In the case where, after computation, a segment of the exit surface S1 is planar or conical (straight-line segment in section in the figures), the modification of the optical path can be achieved by shifting (translating) this segment in the direction of the wave R2 that passes through it by a length equal to (1−n1)×c.

In a first non-limiting embodiment, when the exit surface S1 is partly planar (FIGS. 3 and 4), the exit surface S1 of the primary layer 121 is arranged so as to compensate for said shift. This compensation makes it possible to shorten the optical path of the return radar waves R2 for one of the two receive antennas 101. Thus, the arrangement of the last dioptric interface represented by the exit surface S1 through which the return radar waves R2 pass makes it possible to compensate for the shift. To this end, the exit surface S1 comprises a portion 125, called the compensating portion 125, placed in the location where one of the return radar waves R2 crosses said exit surface S1. By virtue of this arrangement of the portion 125, the shift is thus compensated for. This portion is a zone of correction of the additional phase shift. The exit surface S1 is partly planar and comprises the portion 125, which is set back or raised with respect to the planar part. Namely, the portion 125 is either recessed into the material of the primary layer 121 or protrudes with respect to the planar part of the exit surface S1. Said set-back or raised portion 125 is placed so as to be on the path of one of the return radar waves R2 received by one of the two receive antennas 101 of said radar sensor 10. The optical path of this return radar wave R2 is thus modified so that the shift between the phase difference Δφ between the return radar waves R2 received by each receive antenna 101 and the phase difference Δφ0 allowing the radar to compute the exact azimuth angle χ is compensated for.

Thus, in the non-limiting embodiment illustrated in FIG. 3, the portion 125 is in relief, and in section is trapezoidal in shape. It will be noted that the portion of the exit surface S1 drawn with a dotted line shows where the exit surface S1 would be, in the same place as the portion 125, if there was no compensation and therefore if the portion 125 did not exist.

Thus, in the non-limiting embodiment illustrated in FIG. 4, the portion 125 is in relief, and in section is rectangular in shape. It will be noted that the portion of the exit surface S1 drawn with a dotted line shows where the exit surface S1 would be, in the same place as the portion 125, if there was no compensation and therefore if the portion 125 did not exist. The entrance surface S2 of the second secondary layer 122b is parallel to the exit surface S1, including the portion 125. It will be noted that the case illustrated takes into account the fact that n1=n3.

It will be noted that if there are a plurality of secondary layers 122, an equivalent refractive index is defined for the computation of the phase difference Δφ. Thus, these various secondary layers 122 will be seen as a single homogeneous secondary layer, and the portion 125 will be adjusted depending on this homogeneous secondary layer.

In a second non-limiting embodiment, when the exit surface S1 is continuous and non-planar, namely continuous and curved (FIGS. 2 and 5), the shift is compensated for by a compensation function of the processing unit 21. Specifically, in this case, compensation cannot be achieved by modifying the exit surface S1 by means of a portion 125.

Thus, either the shift is corrected physically by making the exit surface S1 discontinuous by means of the portion 125 and by adjusting the depth 125, or it is done digitally by the processing unit 21.

Of course, the description of the invention is not limited to the embodiments described above and to the field described above. Thus, in another non-limiting embodiment, the radar sensor 10 comprises more than one transmit antenna 100 and more than two receive antennas 101. Thus, in another non-limiting embodiment, the layered arrangement 12 comprises more than two secondary layers 122. Thus, the layered arrangement 12 may comprise other secondary layers 122. Thus, in non-limiting examples, the other secondary layers 122 are a layer that is scattering, and/or a layer that is reflective, and/or a layer that is opaque, in the visible range. Thus, in another non-limiting embodiment, instead of a correction function f1 computed by the processing unit 21, it is possible to perform a calibration before the radar sensor 10 is used in order to obtain a correction table that will be used by the processing unit 21. Calibration will be carried out by placing a target object 3 at various predetermined angles and by noting the values of these angles measured by the radar sensor 10, which values contain an error due to the predetermined shape 124 of the secondary layer 122. Thus, in one non-limiting example, the correction table will thus contain the values of the predetermined angles and the corresponding values of the angles measured by the radar sensor 10, and the processing unit 21 will thus compute the difference in values to be applied for the correction. In another non-limiting example, the correction table will contain the values of the predetermined angles and the corresponding correction values to be applied.

Thus, the described invention in particular has the following advantages:
it allows the computation of the angular position Pos of a target object 3 not to be impacted by a 3D shape of a layer in the layered arrangement 12,
it prevents the radar sensor 10 from detecting false target objects,
it makes it possible to correct errors in measurement by the radar sensor 10 of the phase shift Δφ.

What is claimed is:

1. A vehicular assembly for a vehicle, the vehicular assembly being configured to detect a target object in the environment of the vehicle and comprising:
a radar sensor including at least one transmit antenna configured to transmit radar waves and at least two receive antennas configured to receive return radar waves reflected by the target object,
a layered arrangement including:
(i) a primary layer placed facing the radar sensor and including an exit surface for the return radar waves, and
(ii) at least one secondary layer comprising an entrance surface of the return radar waves, and
(iii) at least one non-planar predetermined shape present in the primary layer or in at least one secondary layer,
with the exit surface of the primary layer is computed depending on the at least one predetermined shape, so that return waves reach the at least two receive antennas with the same angle of incidence regardless of the position of the target object.

2. The vehicular assembly as claimed in claim 1, wherein the primary layer and the at least one secondary layer are merged into a single layer.

3. The vehicular assembly as claimed in claim 1, wherein the primary layer and the at least one secondary layer are distinct and each has a different refractive index.

4. The vehicular assembly as claimed in claim 1, wherein the exit surface of the primary layer is computed according to the equation A(u, 0)=A(u, L) for any angle u within the field of view of the radar sensor, L being the distance between the at least two receive antennas.

5. The vehicular assembly as claimed in claim 1, wherein the shape of the exit surface is determined by a finite-difference method.

6. The vehicular assembly as claimed in claim 1, wherein the phase difference measured by the radar sensor corrected by a correction function of a processing unit of the vehicle.

7. The vehicular assembly as claimed in claim 1, wherein the layered arrangement forms a logo or layers of a headlamp or tail lamp.

8. The vehicular assembly as claimed in claim 1, wherein the predetermined shape is a relief formed from planar or conical surfaces.

9. The vehicular assembly as claimed in claim 8, wherein the exit surface of the primary layer is partly planar and includes a portion that is set back or raised with respect to the planar part and that is configured to compensate for a shift induced by the predetermined shape in the phase difference between the return radar waves received by each receive antenna.

10. The vehicular assembly as claimed in claim 1, wherein the primary layer has a primary refractive index, and the layered arrangement includes two secondary layers each with a secondary refractive index and a tertiary refractive index, respectively, one layer of the layers including the entrance surface of the return radar waves and possessing the tertiary refractive index, the entrance surface being partially parallel to the exit surface and the tertiary refractive index being the same as the primary refractive index.

11. The vehicular assembly as claimed in claim 1, wherein the predetermined shape is curved and is a smooth surface.

12. A layered arrangement placed facing a radar sensor, the radar sensor including at least one transmit antenna configured to transmit radar waves and at least two receive antennas configured to receive return radar waves reflected by a target object, the layered arrangement comprising:
(i) a primary layer placed facing the radar sensor and including an exit surface of the return radar waves,
(ii) at least one secondary layer including an entrance surface of the return radar waves,
at least one non-planar predetermined shape present in the primary layer or in at least one secondary layer,
wherein the exit surface of the primary layer is computed depending on the at least one predetermined shape of the entrance surface, so that return waves reach the at least two receive antennas with the same angle of incidence regardless of the position of the target object.
